(19) United States
(12) Patent Application Publication
(10) Pub. No.: US 2022/0307674 A1
(43) Pub. Date: Sep. 29, 2022

(54) SAFETY PROTECTION CUSHION PUSHING SYSTEM AND CORRESPONDING TERMINAL

(71) Applicant: Ningbo Huina Machinery Co., Ltd, hejiang Province (CN)

(72) Inventor: Aili Zhou, Hunan (CN)

(21) Appl. No.: 17/295,293

(22) PCT Filed: Aug. 18, 2020
(86) PCT No.: PCT/CN2020/109737

§ 371 Date: May 19, 2021

(30) Foreign Application Priority Data
Jul. 6, 2020 (CN) 202010641040.X

(51) Int. Cl. F21V 15/04; G06V 10/50

(52) U.S. Cl. CPC F21V 15/04; G06V 10/50

(57) ABSTRACT

The present invention relates to a safety protection cushion pushing system and a corresponding terminal, including: a cushion pushing mechanism, which is used to open a flat cushion structure near a chandelier when a first driving signal is received, and to push the opened flat cushion structure directly below the chandelier; the cushion pushing mechanism includes a signal receiving device, an automatic opening device, and an on-site pushing device, wherein the automatic opening device includes a first drive motor and a unfolding structure which is connected to the first drive motor, and the on-site pushing device includes a second drive motor and a mechanical arm connected with the second drive motor. The present invention is able to identify when the chandelier is too close to the ground, and consequently trigger the protection operation in time to prevent the scene of the chandelier colliding with the ground.

### TECHNICAL FIELD

The present invention relates to the field of adaptive control, in particular to a safety protection cushion pushing system and a corresponding terminal.

### BACKGROUND ART

In daily life, the so-called self-adaptation refers to a feature that organisms can change their habits to adapt to a new environment. Therefore, intuitively speaking, a self-adaptive controller should be a controller that can modify its characteristics to adapt to changes in the dynamic characteristics of the object and disturbance.

Self-adaptive control, similar to conventional feedback control and optimal control, is also a control method based on mathematical models. The difference is that self-adaptive control is based on less prior knowledge about models and disturbances, and the information about the model needs to be continuously extracted in the system operation process, so that the model is gradually improved. Specifically, the model parameters can be continuously identified based on the input and output data of the object. This process is called the online identification of the system. As the production process continues, through online identification, the model will become more and more accurate and closer to reality. Since the model is constantly improving, obviously, the control function synthesized based on this model will also be continuously improved. In this sense, the control system has certain adaptability. For example, when the system is in the design stage, due to the lack of initial information about the object characteristics, the system may not perform well when it is first put into operation, but after a period of operation, after online identification and control, the control system gradually adapts, and finally self-adjusted to a satisfactory working condition. For another example, the characteristics of some control objects may undergo major changes during operation, but the system can gradually adapt through online identification and changing controller parameters.

### SUMMARY OF THE INVENTION

In order to solve the related technical problems in the prior art, the present invention provides a safety protection cushion pushing system, which is able to identify when the chandelier is too close to the ground, and trigger the protection operation in time to prevent the scene of the chandelier colliding with the ground, thereby effectively protecting the chandelier facilities and avoiding the loss in economic benefits of the chandelier user.

For this reason, the present invention needs at least the following two important invention aspects:
(1) Using a high-precision detection mechanism to trigger the cushion pushing mechanism when it is detected that the chandelier is too close to the ground to open the flat cushion structure near the chandelier and to push the opened flat cushion structure directly below the chandelier;
(2) Introducing a customized cushion pushing mechanism including a signal receiving device, an automatic opening device, and an on-site pushing device to realize automatic unfolding and pushing control of the cushion. The automatic opening equipment includes a first drive motor and an unfolding structure connected with the first drive motor. The on-site pushing device includes a second drive motor and a mechanical arm connected with the second drive motor.

According to one aspect of the present invention, a safety protection cushion pushing system is provided, and the system includes:

a cushion pushing mechanism, which is used to open a flat cushion structure near a chandelier when a first driving signal is received, and to push the opened flat cushion structure directly below the chandelier;

the cushion pushing mechanism includes a signal receiving device, an automatic opening device, and an on-site pushing device, wherein the automatic opening device includes a first drive motor and an unfolding structure which is connected to the first drive motor, and the on-site pushing device includes a second drive motor and a mechanical arm connected with the second driving motor;

the cushion pushing mechanism is also used for not performing the opening operation and the pushing operation of the flat cushion structure near the chandelier when a second driving signal is received;

a real-time sensing mechanism, which is set on the bottom plane of the chandelier, and is used to perform real-time image sensing actions on the scene below the chandelier to obtain corresponding on-site sensing images;

a smooth space filtering device, which is packaged in the bottom of the chandelier, connected to the real-time sensing mechanism, and is used for performing smooth space filtering processing on the received on-site sensing image to obtain and output a corresponding smoothing space filtered image;

an edge sharpening device, which is connected to the smooth space filtering device, and is used to perform edge sharpening processing on the received smooth space filtered image to obtain and output a corresponding edge sharpened image;

a data enhancement device, which is connected to the edge sharpening device, and is used to perform a histogram equalization processing based on a density function on the received edge sharpened image to obtain and output a corresponding data enhanced image;

a content recognition mechanism, which is connected to the data enhancement device, and is used to recognize each pixel point in the data enhanced image that matches the ground color imaging feature as each target pixel point, and obtain the depth of field of each target pixel point in the data enhanced image;

a numerical value conversion device, which is respectively connected with the cushion pushing mechanism and the content recognition mechanism, and is used to send a first driving signal when the received intermediate value of each depth of field of each target pixel is lower than a preset depth of field threshold.

According to another aspect of the present invention, a safety protection cushion pushing terminal is further provided, characterized in that, the terminal includes: a memory and a processor, wherein the processor is connected to the memory; the memory is used to store executable instructions of the processor; the processor is configured to call executable instructions in the memory to realize the use of the safety protection cushion pushing system, by identifying the scene that the chandelier is too close to the ground basing on a targeted visual detection mechanism, to implement a self-adaptive method in safety protection operation.

The safety protection cushion pushing system and the corresponding terminal of the present invention is simple in structure, and is convenient and practical in application. It is able to identify when the chandelier is too close to the ground, and consequently trigger the protection operation in time to prevent the scene of the chandelier colliding with the ground, thereby effectively protecting the chandelier facilities and avoiding the loss in economic benefits of the chandelier user.

### DESCRIPTION OF ACCOMPANIED FIGURE

The embodiments of the present invention will be described below with reference to the accompanying figure, in which:

FIG. 1 is an outline structure diagram of a chandelier used in the safety protection cushion pushing system according to an embodiment of the present invention.

### DETAILED IMPLEMENTATION METHOD

The implementation of the safety protection cushion pushing system and corresponding terminal of the present invention will be described in detail below with reference to the accompanying figure.

Motor control refers to the control of starting, accelerating, running, decelerating and stopping the motor. There are different requirements and purposes according to different motor models and motor use occasions.

For step-down starting, it mainly includes: autotransformer starting, star-delta change starting, and variable voltage starting. When the asynchronous motor starts, the rotor is at a standstill, and its slip rate s=1. At this time, the rotor side resistance of the T-type equivalent circuit is very low, so the starting current is larger, and the starting current can be reduced by step-down starting. Since the starting torque of an asynchronous motor is proportional to the square of the voltage, it is necessary to ensure that the motor has a certain starting ability for step-down starting.

The method of increasing the rotor loop starting is suitable for wound rotors, deep slot rotors and double cage rotors. This method cannot be used for squirrel cage rotors.

When the rotor resistance of the asynchronous motor is increased, the maximum torque of the motor will not be affected, but the point of occurrence of the maximum torque will move, and the motor torque-slip curve will be compressed along the slip axis. Since the motor curve has a tendency to increase first and then decrease with respect to slip, the starting torque of the motor will increase. However, its value is affected by the maximum torque of the motor.

The starting methods of single-phase asynchronous motors include: capacitor starting, resistance starting, PTC starting, shaded pole starting, etc.

Since the single-phase winding of the induction motor cannot generate a rotating magnetic potential when the rotor is stationary, an asynchronous motor with only a single-phase winding cannot start automatically. In this regard, it is necessary to install an auxiliary winding 90° from the main winding on the single-phase asynchronous motor. This winding is mainly used to start the motor. When the motor is started, it can be cut off or used for the operation of the motor.

In the prior art, due to the problem of the chandelier itself or due to installation problem, the chandelier may fall off its upper hook and drops to the ground. Once it hits a rigid ground, the chandelier may break. On the one hand, it brings troubles to the users of the chandelier facilities for cleaning and disposal, and on the other hand, it also brings economic losses to the users of the chandelier facilities.

In order to overcome the above shortcomings, the present invention builds a safety protection cushion pushing system and corresponding terminal, which can effectively solve the corresponding technical problems.

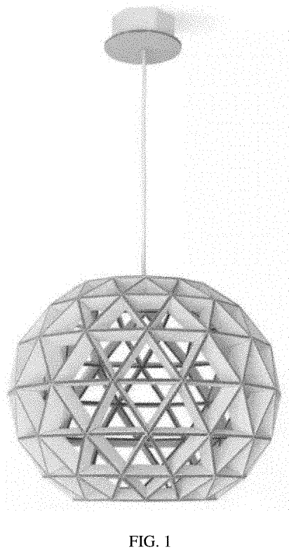

FIG. 1 is an outline structure diagram of a chandelier applied to a safety protection cushion pushing system according to an embodiment of the present invention.

The safety protection cushion pushing system shown according to the embodiment of the present invention includes:

a cushion pushing mechanism, which is used to open a flat cushion structure near a chandelier when a first driving signal is received, and to push the opened flat cushion structure directly below the chandelier;

the cushion pushing mechanism includes a signal receiving device, an automatic opening device, and an on-site pushing device, wherein the automatic opening device includes a first drive motor and an unfolding structure which is connected to the first drive motor, and the on-site pushing device includes a second drive motor and a mechanical arm connected with the second driving motor;

the cushion pushing mechanism is also used for not performing the opening operation and the pushing operation of the flat cushion structure near the chandelier when a second driving signal is received;

a real-time sensing mechanism, which is set on the bottom plane of the chandelier, and is used to perform real-time image sensing actions on the scene below the chandelier to obtain corresponding on-site sensing images;

a smooth space filtering device, which is packaged in the bottom of the chandelier, connected to the real-time sensing mechanism, and is used for performing smooth space filtering processing on the received on-site sensing image to obtain and output a corresponding smoothing space filtered image;

an edge sharpening device, which is connected to the smooth space filtering device, and is used to perform edge sharpening processing on the received smooth space filtered image to obtain and output a corresponding edge sharpened image;

a data enhancement device, which is connected to the edge sharpening device, and is used to perform a histogram equalization processing based on a density function on the received edge sharpened image to obtain and output a corresponding data enhanced image;

a content recognition mechanism, which is connected to the data enhancement device, and is used to recognize each pixel point in the data enhanced image that matches the ground color imaging feature as each target pixel point, and obtain the depth of field of each target pixel point in the data enhanced image;

a numerical value conversion device, which is respectively connected with the cushion pushing mechanism and the content recognition mechanism, and is used to send a first driving signal when the received intermediate value of each depth of field of each target pixel is lower than a preset depth of field threshold.

Next, the specific structure of the safety protection cushion pushing system of the present invention is further described as follow.

In the safety protection cushion pushing system:

the numerical value conversion device is also used for sending a second driving signal when the received intermediate value of each depth of field of each target pixel is not less than a preset depth of field threshold.

The safety protection cushion pushing system further includes:

a FLASH storage device, which is connected to the content recognition mechanism, and is used to store the ground color imaging feature;

wherein, the ground color imaging feature is a ground red channel distribution range, a ground green channel distribution range, and a ground blue channel distribution range.

The safety protection cushion pushing system further includes:

a user input interface, which is connected to the FLASH storage device, and is used to input the ground color imaging feature according to a user's operation to send the ground color imaging feature to the FLASH storage device.

In the safety protection cushion pushing system:

the edge sharpening device, the data enhancement device, the content recognition mechanism and the numerical value conversion device are all packaged in the bottom of the chandelier.

The safety protection cushion pushing system further includes:

a pressure detection device, which is arranged on the casing of the content recognition mechanism, and is used to measure the instantaneous pressure that the casing of the content recognition mechanism is currently subjected to;

a pressure analysis device, which is connected to the pressure detection device and is used to issue a pressure alarm instruction when the received instantaneous pressure exceeds a limit;

wherein, the pressure analysis device is also used to issue a normal pressure instruction when the received instantaneous pressure does not exceed the limit.

The safety protection cushion pushing system further includes:

an alarm execution device, which is connected to the pressure analysis device and is used to execute a corresponding alarm operation when a pressure alarm instruction is received.

In the safety protection cushion pushing system:

the alarm execution device is a buzzer, which is used to emit a buzzing sound with a preset frequency when performing a corresponding alarm operation.

In the safety protection cushion pushing system:

the alarm execution device is a voice playback chip, which is used to play the corresponding alarm file when the corresponding alarm operation is performed;

wherein, the alarm execution device is a display device, which is used to display a corresponding alarm text when the corresponding alarm operation is performed;

wherein, the alarm execution device is also used to stop executing the corresponding alarm operation when receiving a normal pressure instruction.

At the same time, in order to overcome the above shortcomings, the present invention also builds a safety protection cushion pushing terminal, and the terminal includes: a memory and a processor, wherein the processor is connected to the memory;

wherein the memory is used to store executable instructions of the processor;

wherein the processor is configured to call executable instructions in the memory to realize the use of the safety protection cushion pushing system, by identifying the scene that the chandelier is too close to the ground basing on a targeted visual detection mechanism, to implement a self-adaptive method in safety protection operation.

In addition, the FLASH memory chip is a non-volatile memory, which can erase and reprogram memory cell blocks called blocks. The writing operation of any FLASH device can only be performed in blank or erased cells, so in most cases, the erase must be performed before the writing operation. It is very simple for NAND devices to perform an erase operation, while NOR requires that all bits in the target block be written as 0 before erasing.

Since NOR devices are erased in blocks of 64-128 KB, the time to perform a write/erase operation is 5s. In contrast, erasing NAND devices is performed in blocks of 8-32 KB, and the same operation only takes 4 ms at most.

The difference in block size when performing erase further widens the performance gap between NOR and NADN. Statistics show that for a given set of writing operations (especially when updating smaller files), more erase operations must be performed in NOR-based cells.

It should be understood that each part of the present invention can be implemented by hardware, software, firmware or a combination of them. In the above embodiments, multiple steps or methods can be implemented by software or firmware stored in a memory and executed by a suitable instruction execution system. For example, if it is implemented by hardware, as in another embodiment, it can be implemented by any one or a combination of the following technologies known in the art: discrete logic circuits with logic gate circuits used to implement logic functions on data signals, application-specific integrated circuits with suitable combinational logic gate circuits, programmable gate array (PGA), field programmable gate array (FPGA), etc.

A person of ordinary skill in the art can understand that all or part of the steps carried in the method of the foregoing embodiments can be implemented by a program instructing relevant hardware to complete. The program can be stored in a computer-readable storage medium. When executed, it includes one of the steps of the method embodiment or a combination thereof.

The aforementioned storage medium may be a read-only memory, a magnetic disk or an optical disk, etc. Although the embodiments of the present invention have been shown and described above, it can be understood that the above-mentioned embodiments are exemplary and should not be construed as limiting the present invention. Those of ordinary skill in the art may make changes, modifications, substitutions, and transformation on the above-mentioned embodiments within the scope of the present invention.

1. A safety protection cushion pushing system, characterized in that, the system includes:
a cushion pushing mechanism, which is used to open a flat cushion structure near a chandelier when a first driving signal is received, and to push the opened flat cushion structure directly below the chandelier;
the cushion pushing mechanism includes a signal receiving device, an automatic opening device, and an on-site pushing device, wherein the automatic opening device includes a first drive motor and an unfolding structure which is connected to the first drive motor, and the on-site pushing device includes a second drive motor and a mechanical arm connected with the second driving motor;
the cushion pushing mechanism is also used for not performing the opening operation and the pushing operation of the flat cushion structure near the chandelier when a second driving signal is received;
a real-time sensing mechanism, which is set on the bottom plane of the chandelier, and is used to perform real-time image sensing actions on the scene below the chandelier to obtain corresponding on-site sensing images;
a smooth space filtering device, which is packaged in the bottom of the chandelier, connected to the real-time sensing mechanism, and is used for performing smooth space filtering processing on the received on-site sensing image to obtain and output a corresponding smoothing space filtered image;
an edge sharpening device, which is connected to the smooth space filtering device, and is used to perform edge sharpening processing on the received smooth space filtered image to obtain and output a corresponding edge sharpened image;
a data enhancement device, which is connected to the edge sharpening device, and is used to perform a histogram equalization processing based on a density function on the received edge sharpened image to obtain and output a corresponding data enhanced image;
a content recognition mechanism, which is connected to the data enhancement device, and is used to recognize each pixel point in the data enhanced image that matches the ground color imaging feature as each target pixel point, and obtain the depth of field of each target pixel point in the data enhanced image;
a numerical value conversion device, which is respectively connected with the cushion pushing mechanism and the content recognition mechanism, and is used to send a first driving signal when the received intermediate value of each depth of field of each target pixel is lower than a preset depth of field threshold.

2. The safety protection cushion pushing system according to claim 1, characterized in that:
the numerical value conversion device is also used for sending a second driving signal when the received intermediate value of each depth of field of each target pixel is not less than a preset depth of field threshold.

3. The safety protection cushion pushing system according to claim 2, characterized in that, the system further includes:
a FLASH storage device, which is connected to the content recognition mechanism, and is used to store the ground color imaging feature;
wherein, the ground color imaging feature is a ground red channel distribution range, a ground green channel distribution range, and a ground blue channel distribution range.

4. The safety protection cushion pushing system according to claim 3, characterized in that, the system further includes:
a user input interface, which is connected to the FLASH storage device, and is used to input the ground color imaging feature according to a user's operation to send the ground color imaging feature to the FLASH storage device.

5. The safety protection cushion pushing system according to claim 4, characterized in that:
the edge sharpening device, the data enhancement device, the content recognition mechanism and the numerical value conversion device are all packaged in the bottom of the chandelier.

6. The safety protection cushion pushing system according to claim 5, characterized in that, the system further includes:
a pressure detection device, which is arranged on the casing of the content recognition mechanism, and is used to measure the instantaneous pressure that the casing of the content recognition mechanism is currently subjected to;
a pressure analysis device, which is connected to the pressure detection device and is used to issue a pressure alarm instruction when the received instantaneous pressure exceeds a limit;
wherein, the pressure analysis device is also used to issue a normal pressure instruction when the received instantaneous pressure does not exceed the limit.

7. The safety protection cushion pushing system according to claim 6, characterized in that, the system further includes:
an alarm execution device, which is connected to the pressure analysis device and is used to execute a corresponding alarm operation when a pressure alarm instruction is received.

8. The safety protection cushion pushing system according to claim 7, characterized in that:
the alarm execution device is a buzzer, which is used to emit a buzzing sound with a preset frequency when performing a corresponding alarm operation.

9. The safety protection cushion pushing system according to claim 8, characterized in that:
the alarm execution device is a voice playback chip, which is used to play the corresponding alarm file when the corresponding alarm operation is performed;
wherein, the alarm execution device is a display device, which is used to display a corresponding alarm text when the corresponding alarm operation is performed;
wherein, the alarm execution device is also used to stop executing the corresponding alarm operation when receiving a normal pressure instruction.

10. A safety protection cushion pushing terminal, characterized in that, the terminal includes: a memory and a processor, wherein the processor is connected to the memory;
the memory is used to store executable instructions of the processor;
the processor is configured to call executable instructions in the memory to realize the use of the safety protection cushion pushing system according to claim 1, by identifying the scene that the chandelier is too close to the ground basing on a targeted visual detection mechanism, to implement a self-adaptive method in safety protection operation.
